(19) United States
(12) Patent Application Publication
(10) Pub. No.: US 2016/0152822 A1
(43) Pub. Date: Jun. 2, 2016

(54) 1K THERMOSET EPOXY COMPOSITION

(71) Applicant: DOW GLOBAL TECHNOLOGIES LLC, Midland, MI (US)

(72) Inventors: Matthew T. Bishop, Midland, MI (US); Jodi M. Mecca, Midland, MI (US); Manesh Nadupparambil Sekharan, Midland, MI (US); Robert W. Sandoval, Midland, MI (US)

(21) Appl. No.: 14/906,032

(22) PCT Filed: Aug. 12, 2014
(86) PCT No.: PCT/US14/50612

§ 371 Date: Jan. 19, 2016

Related U.S. Application Data
(60) Provisional application No. 61/866,571, filed on Aug. 16, 2013.

(51) Int. Cl. C08L 63/04; C08G 59/44; C08G 59/68; C08G 59/22

(52) U.S. Cl. CPC C08L 63/04; C08G 59/226; C08G 59/44; C08G 59/686; C08L 2205/02

(57) ABSTRACT

Novel one-part thermoset composition capable of being combined with a reinforcement component such as continuous, woven mat, chopped or recycled fibers in a process to create a molding compound for the formation of composites.

### FIELD OF THE INVENTION

As the automotive industry moves towards more fuel efficient cars, one path to reducing fuel usage is to reduce the vehicle weight. However, the weight needs to be reduced without sacrificing vehicle integrity and safety. Reinforced composites such as carbon fiber composites offer a material that is lower density while retaining similar mechanical properties as those of steel and aluminum. However, traditional methods for the preparation of such composites are often labor intensive and slow, making them incompatible with the speed and automation typically required in automotive plants. The present invention provides a composite that contains solid epoxy-terminated polyoxazolidone resins to allow for production of low tack prepregs or carbon fiber molding compounds with easy automated handling while enabling high cured glass transition temperatures.

The present invention also relates to a one-part thermoset composition that can be combined with a reinforcement component such as continuous, woven mat, chopped or recycled fibers in a melt to create a moldable compound for the formation of composites. This composition enables non-refrigerated, shelf-stable, low tack pre-pregs for automated handling and fast compression molding cycle times, e.g., under 3 minutes. In systems with chopped or recycled fiber, the composition of the present invention allows for excellent viscosity control, fiber wet-out, and non-refrigerated shelf-stable carbon-fiber epoxy molding compounds with compression molding processing cycle times of under 3 minutes. The composition of the present invention makes cost-effective high-volume manufacture of composite parts possible.

### SUMMARY OF THE INVENTION

The resin composition of the present invention comprises a solid epoxy-terminated polyoxazolidone resin and some additional epoxy resin(s) based on bisphenol A (“bis-A”) epoxy resin or epoxy novolac resins. The resin composition may be cured with a latent hardener such as dicyandiamide (“DICY”) in the presence of a latent catalyst such as a substituted urea. These resin compositions are capable of being made at temperatures below when significant curing occurs (<120° C.). The composition also displays room temperature storage stability, and is able of being rapidly cured (<5 minutes) to high glass transition temperature (T_{g}) (≧150° C.) at curing temperatures near 150° C. In the case of chopped or recycled fibers, the fiber may be added to the resin composition to form a blend with sufficient flow ability to enable fiber and resin to fill complex molds with very little resin separation.

### BRIEF DESCRIPTION OF THE DRAWINGS

FIG. 1 illustrates a twin screw extrusion process for making random fiber molding compound.

FIG. 2 illustrates a molded composite part with complex shape.

### DETAILED DESCRIPTION OF THE INVENTION

### Epoxy-Terminated Polyoxazolidone Resins

Epoxy-terminated polyoxazolidone resins are reaction product formed by reacting a polyepoxide compound with a polyisocyanate compound. A representative chemical structure of such an oxazolidone is shown below in Formula I:

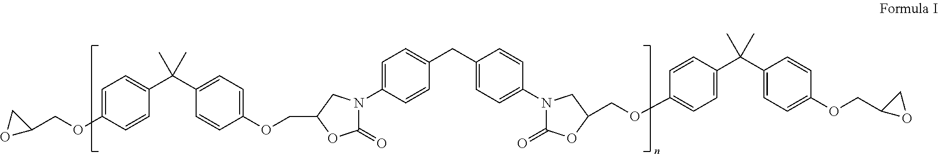

The polyepoxide compound useful in the present invention is suitably a compound which possesses more than one 1,2-epoxy group. In general, the polyepoxide compound is saturated or unsaturated aliphatic, cycloaliphatic, aromatic or heterocyclic compound which possesses more than one 1,2-epoxy group. The polyepoxide compound can be substituted with one or more substituents which are non-reactive with the isocyanate groups such as lower alkyls and halogens. Such polyepoxide compounds are well known in the art. Illustrative polyepoxide compounds useful in the practice of the present invention are also described in the Handbook of Epoxy Resins by H. E. Lee and K. Neville published in 1967 by McGraw-Hill, New York and U.S. Pat. No. 4,066,628.

Particularly useful polyepoxide compounds, which can be used in the present invention, are polyepoxides having the following general formula

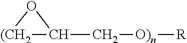

wherein R is substituted or unsubstituted aromatic, aliphatic, cycloaliphatic or heterocyclic polyvalent group and n has an average value of from greater than about 1 to less than about 5. The preferred diepoxides include diglycidyl ether of 2,2-bis(4-hydroxyphenyl) propane (generally referred to as bisphenol A) and diglycidyl ether of 2,2-bis(3,5-dibromo-4-hydroxyphenyl) propane (generally referred to as tetrabromobisphenol A) and any mixture thereof.

The polyisocyanate compound useful in the present invention is represented by the following general formula: (O═C═N)ₘ—R′, wherein R′ is substituted or unsubstituted aliphatic, aromatic or heterocyclic polyvalent group and m has an average value of greater than about 1 to less than about 5, preferably from about 1.5 to about 4, most preferably from about 2 to about 3. Examples of suitable polyisocyanates include 4,4′-methylene bis(phenylisocyanate) (MDI) and isomers thereof, higher functional homologs of MDI (commonly designated as “polymeric MDI”), toluene diisocyanate (TDI) such as 2,4-toluene diisocyanate and 2, 6-toluene diisocyanate, m-xylylene diisocyanate, hexamethylene diisocyanate (HMDI) and isophoronediisocyanate or any mixture thereof. Other suitable polyisocyanate compounds are described in U.S. Pat. Nos. 3,313,747; 4,066,628 and 4,742,146.

Preferred polyisocyanate compounds are 4,4′-methylene bis(phenylisocyanate) (MDI) and isomers thereof, polymeric MDI and toluene diisocyanate (TDI). The most preferred polyisocyanate compounds are 4,4′-methylene bis(phenylisocyanate), isomers thereof and polymeric MDI.

A suitable catalyst is employed in the present invention to facilitate reaction of the polyepoxide compound with the polyisocyanate compound. Examples of suitable catalysts include zinc carboxylate, organozinc chelate compound, trialkyl aluminum, quaternary phosphonium and ammonium salts, tertiary amines and imidazole compounds. The preferred catalysts are imidazole compounds. Particularly, preferred catalysts are 2-phenylimidazole 2-methylimidazole, 1-methylimidazole, 2-ethyl-4-methylimidazole and 4,4′-methylene-bis(2-ethyl-5-methylimidazole).

The catalyst is generally employed in an amount of from about 0. 01 to about 2; preferably from about 0.02 to about 1, most preferably from about 0.02 to about 0.1, weight percent based on the combined weight of the polyepoxide compound and polyisocyanate compound used.

It has been found that the use of an epoxy-terminated polyoxazolidone in a resin composition of the present invention reduces the tackiness of the composition and the resultant composite precursors such as prepregs and molding compounds while still maintaining high T_{g}values of the cured compositions and cured composites. Tackiness is a function of T_{g}and molecular weight of the combination of resins in the composition. Therefore, to reduce tackiness at ambient temperatures, the inclusion of some fraction of component resins with T_{g}above ambient temperature in the composition is desirable. Higher molecular weight of the resin can further reduce tackiness, in particular the rate at which two surfaces stick together. Solid epoxy resins have T_{g}above ambient temperature and have higher molecular weight than those of liquid epoxy resins. Therefore, inclusion of some fraction of solid epoxy resins in the composition is desirable for reducing tackiness. However, it has also been found that when using a solid epoxy resin without the oxazolidone group, the tackiness is reduced but the T_{g}of the cured resin composition is below 130° C. which is too low for many applications. Surprisingly, when a solid epoxy-terminated polyoxazolidone resin is used, the resulting resin composition not only has reduced tackiness as other solid epoxy resins would but also offers a higher T_{g}(T_{g}≧150° C.) after curing the resin composition. A T_{g}greater than 20° C. before cure will result in low tack. Low tack is beneficial if materials or composite precursors are handled in an automated process. Having low tack will allow materials or composite precursors to be cut, picked up and placed, and stacked without sticking to tables, grippers or other materials. Low tack also avoids self-sticking of composite precursors which can be useful in adjusting placement of prepreg layers during automated layup. High T_{g}after cure enables sample materials that are molded to be demolded (in the presence of internal or external mold release agent) at cure temperature without warping. This in turn increases the throughput of composite materials production. For instance, if a material can be compression molded at 150° C. such that a Tg greater than the molding temperature results (e.g., T_{g}=155° C.), then the material can be demolded at the compression molding temperature. High T_{g}after cure can also be beneficial for improved heat resistance in the final application. It also provides less creep and better dimensional stability at above-ambient use temperatures and at high temperatures that might be required for curing of coatings.

### Resin Composition

The resin composition of the present invention comprises 1) a solid epoxy-terminated polyoxazolidone resin (e.g., D.E.R.™ 6508 or D.E.R.™ 6510 available from The Dow Chemical Company) and 2) some additional epoxy resin(s) such as glycidyl ether epoxy resins based on bisphenol A (e.g., D.E.R.™ 331 available from The Dow Chemical Company) or glycidyl ether epoxy resins based on phenol-formaldehyde novolacs (e.g., D.E.N.™ 438 or D.E.N.™ 439 also available from The Dow Chemical Company) or cycloaliphatic glycidyl ether resins (e.g.,(cyclohexanol, 4,4-(1-methylethylidene)bis-, polymer with (chloromethyl), (3,4 epoxy cyclohexyl methyl 3,4 epoxy cyclohexyl carboxylate)) or bisphenol F epoxy resin (e.g., D.E.R. 354). The resin composition may be cured with 3) a latent hardener such as DICY, guanidines, or anhydrides in the presence of 4) a latent catalyst such as a substituted urea and/or modified imidazole (e.g., 2-phenyl-imidazole, 2,4-diamino-6-[2′-methylimidazolyl-(1′)]-ethyl-s-triazine, 2,4-diamino-6-[2′-methyl imidazolyl-(1′)]-ethyl-s-triazine isocyanuric acid adduct dehydrate). Depending on specific applications of the present invention, the resin composition may further comprise other components such as water, solvents, dispersants, inorganic fillers, toughening agents, internal mold release agents, flow aids, additives for specific purposes such as wetting agents, and/or reactive diluents.

In a typical embodiment of the present invention, the resin composition contains

1) about 30 to 100 wt %, preferably 50 to 100 wt %, and more preferably 50 to 80 wt % of oxazolidone-containing solid epoxy resin such as epoxy-terminated polyoxazolidone resin;

2) 0 to 30 wt % of one or more liquid bis-A based epoxy resins; or 0 to 60 wt % of epoxy novolac resins; or both bis-A based epoxy and novolac resins. In a preferred embodiment, the resin composition comprises 0 to 10 wt % liquid epoxy resin and 25 to 45 wt % epoxy novolac resin. In another preferred embodiment, the resin composition comprises 20 to 50 wt % of epoxy novolac resins. In another preferred embodiment, the resin composition comprises 10 to 20 wt % liquid epoxy resin and 40 to 60 wt % epoxy novolac resin.

3) a latent hardener (e.g., DICY, HEW=21) in an amount relative to the epoxy blend of 1) and 2 corresponding to an epoxy/hardener equivalent ratio from 0.5 to 3 where the equivalent ratio is calculated by:

$$\frac{( {m}_{epoxy} / EEW )}{( {m}_{hardener} / HEW )}$$

where m_{epoxy} is the mass of epoxy resin, EEW is equivalent weight per epoxy group of the epoxy component blend, m_{hardener} is the mass of the hardener, and HEW is the equivalent weight per active hydrogen of the hardener blend. Preferably the epoxy/hardener equivalent ratio is 0.75 to 2, more preferably 0.9 to 1.1, most preferably 1.

4) a latent catalyst at a level of 1 to 7 parts per hundred parts resin (PHR of catalyst=100. (m_{catalyst}/m_{epoxy}), where m_{catalyst} is the mass of the catalyst). In a preferred embodiment, the latent catalyst comprises a substituted urea catalyst at a level of 2 to 5 PHR. In another preferred embodiment, the latent catalyst comprises a latent imidazole catalyst at a level of 1 to 3 PHR.

The resin composition of the present invention can be combined with one or more reinforcement agents to form a desired composite. For example, glass, carbon or other fibers may be used as a reinforcement agent to combine with the resin composition to form a composite suitable for automotive part applications. The fibers may be chopped, recycled, or continuous, or in any other form. In a typical process of making the composite, the composite comprises about 25 to 70 wt % of fibers for chopped fiber and 45 to 75 wt % of fiber for continuous fiber with the rest being the resin composition of the present invention. Non-fiber reinforcing agents such as nanoparticulate clays, graphene, nanoparticulate silica, and single- or multi-walled carbon nanotubes can be used in addition to fiber reinforcing agents. In a typical process of making the composite, the composite may comprise about 2 to 30 wt % of non-fiber resinforcing agent.

### EXAMPLES

The present invention can be further illustrated with the following non-limiting examples.

Testing Methods

1. Determination of the glass transition temperature (T_{g}) before and after cure.

The T_{g}was measured using a TA Instruments Q2000 Differential Scanning Calorimeter (DSC). Samples were run under the following 5-step protocol: (1) Heat from −20° C. to 90° C. at 10° C./min; (2) heat from 90° C. to 150° C. at 200° C./min; (3) hold isothermally at 150° C. for 15 minutes; (4) cool from 150° C. to 30° C. at 20° C./min; and (5) heat from 30 to 200° C. The initial T_{g}was determined from the inflection point observed in step (1) and the final T_{g}was determined from the inflection point observed in step (5).

2. Measurement of Tack Force.

Tack force was measured on a custom-made tack and friction testing instrument manufactured by Freeslate, Inc. (Sunnyvale, Calif.). Samples were coated onto 3.08″×4.75″ aluminum substrates using a #2 (2 mm) wire wound bar and dried at 40° C. for 30 minutes. The aluminum substrates were placed in substrate holders (Freeslate P/N S 147344) with backing plates (Freeslate P/N S 121406). The sample was positioned to automatically test each material in different locations using an x-y stage. A 1 cm diameter spherical probe (McMaster Can Catalog #9292K47) was lowered onto the sample by the probe arm of the Freeslate tack and friction tester applying a 100 g normal force for 5 seconds, then removing the probe vertically from the surface at 1 mm/s until the probe released from the substrate. The reported tack is the peak normal force measured (in grams) during the removal of the probe.

Sample Preparations

### 1. Examples 1 and 2, Comparative 1 and 2

Examples 1 and 2 are examples of the present invention prepared from aqueous dispersions and suspensions. The formulations of Examples 1 and 2 were produced from a blend of separate dispersions of an oxazolidone-containing epoxy resin (D.E.R.™ 6508 solid epoxy resin, available from The Dow Chemical Company) and an epoxy novolac resin (D.E.N.™ 438 epoxy novolac resin, available from The Dow Chemical Company), a suspension of the latent hardener dicyandiamide (Technicure® NanoDicy, available from AC Catalysts Inc.) and a suspension of the latent catalyst toluene bis dimethyl urea (“TBDU”) (Omicure™ U-410M, a mixed-isomer TBDU product available from Emerald Performance Materials). Details of the preparation are provided below in separate steps:

Preparation of Dispersion of D.E.R.™ 6508 Solid Epoxy Resin.

D.E.R.™ 6508 solid epoxy resin aqueous dispersion at 58 wt % solids was prepared by an extruder-based mechanical dispersion process with the use of E-SPERSE™ 100 surfactant (available from Ethox Chemical) at a surfactant to epoxy resin ratio of 1:20 by weight. The solid epoxy resin was fed into a twin-screw extruder by means of a solid feeder. The extruder melt zones were set at 110° C. E-SPERSE™ 100 solution (60% active) was also fed into the melt zone of the extruder at a rate relative to the epoxy feed to provide one part surfactant to twenty parts epoxy resin by weight. An initial stream of deionized (DI) water was fed into the molten resin/surfactant mixture at the emulsification zone of the extruder. An additional DI water stream was introduced into the extruder portion downstream of the emulsification zone to dilute the initial emulsified resin to the desired solids level. After filtration, a flowable epoxy dispersion was obtained at 58% solids with relatively narrow particle size distribution, as characterized by volume-average mean particle diameter Dᵥ=0.36 μm and 90^{th} volume-percentile cut-off diameter D₉₀=0.46 μm particle size as measured on a Beckman Coulter LS 13 320 light-scattering analyzer, where the data analysis used an epoxy optical model for differential refractive index.

Preparation of Dispersion of D.E.N.™ 438 Epoxy Novolac Resin.

D.E.N.™ epoxy novolac resin dispersion at 61.5 wt % solids was prepared by a rotor-stator based mechanical dispersion process with the use of E-SPERSE™ 100 surfactant at a surfactant to epoxy resin ratio of 1:25 by weight. The epoxy novolac resin was melted at 80° C. in a heated tank and fed into the shear zone of rotor-stator mixer using a gear pump. E-SPERSE 100 solution (60% active) was fed into the shear zone of the rotor-stator which was maintained at 70° C., adding the amount of solution needed to provide a ratio of one part surfactant to 25 parts epoxy resin by weight. An initial stream of heated (70° C.) DI water was also fed into the shear zone of the rotor-stator. The emulsified resin mixture from the first rotor-stator mixer plus a heated dilution stream of DI water stream were fed into a second rotor-stator mixer to obtain a dispersion at desired solids level. After filtration, a flowable epoxy dispersion was obtained with 61.5 wt % solids and with Dᵥ=0.33 μm particle size as measured on a Beckman Coulter LS 13 320 light-scattering analyzer, where data analysis used an epoxy optical model for differential refractive index.

Preparation of Dicyandiamide Suspension.

An aqueous suspension of DICY hardener at 38.5 wt % solids was prepared from Technicure® NanoDicy (obtained from AC Catalysts Inc.), using a laboratory bench-top Caframo® mixer equipped with a Cowles blade assembly and using polyvinyl alcohol (“PVOH”) as a dispersant. A 27 wt % aqueous solution of Mowiol® 4-88 polyvinyl alcohol (available from Kuraray America) was prepared and was used as dispersant for the DICY at a ratio of one part PVOH to 24 parts DICY by weight. The DICY was stirred with PVOH solution and additional water using the above-described mixer at 2000 rpm for 20 minutes at room temperature to obtain a 37 wt % active suspension of DICY in water (38.5 wt % total solids).

Preparation of OMICURE™ U-410M Suspension.

An aqueous suspension of mixed-isomer toluene bis dimethylurea (“TBDU”) catalyst at 38.5 wt % solids was prepared from OMICURE U-410M (obtained from Diamond Performance Materials) using a laboratory bench-top Caframo® mixer with a Cowles blade assembly and using PVOH as a dispersant. A 27 wt % aqueous solution of Mowiol® 4-88 polyvinyl alcohol (available from Kuraray America) was prepared and used as dispersant for the TBDU at a ratio of one part PVOH to 24 parts TBDU by weight. The Omicure U-410M was stirred with PVOH solution and additional water using the above-described mixer at 2000 rpm for 20 minutes at room temperature to obtain a 37 wt % active suspension of TBDU in water (38.5 wt % total solids).

### Formulation of Examples 1 and 2

Examples 1 and 2 were prepared by blending the D.E.R.™ 6508 solid epoxy resin dispersion, the D.E.N.™ 438 epoxy novolac resin dispersion, the Omicure™ U-410M suspension, and the Technicure® NanoDicy suspension in SpeedMixer™ Laboratory Mixer System (FlackTek Inc.) using a 20 Max cup (Tall) at 1500 rpm for 15 seconds and 2000 rpm for 30 seconds. Table 1 lists the compositions of active components (i.e., epoxy resins, latent hardener, and latent catalyst) of Examples 1 and 2 on a hundred parts resin basis exclusive of water, surfactants, and dispersants.

Comparative Examples 1 and 2 were prepared in the same manner as described above for Examples 1 and 2 with a dispersion of D.E.R.™ 664 solid epoxy resin in place of the D.E.R. 6508 dispersion. The dispersion of D.E.R. 664 was prepared by the same procedure as the dispersion of D.E.R. 6508 and had similar particle size. Table 1 lists the compositions of Comparative Examples 1 and 2 and shows property comparisons for Examples 1 and 2 versus Comparative Examples 1 and 2.

Uncured T_{g}, cured T_{g}, and tack force were measured as described above under Testing Methods. DSC samples of dispersion blends were prepared by placing the aqueous dispersion mixture in the bottom of a pre-weighed hermetic-type DSC pan and drying at approximately 40° C. overnight to obtain 5 to 12 mg of dried sample, then sealing and crimping the pan and lid assembly.

Table 1 shows that Examples 1 and 2 of the present invention have significantly higher cured T_{g}values but similar uncured T_{g}and tack force values as compared to the Comparative Examples 1 and 2, respectively. The results also show that higher levels of solid epoxy resin (i.e., Example 1 and Comparative 1) show lower tack than lower levels of solid epoxy resin although all samples have relatively low tack (<20 g).

TABLE 1
Composition and Properties of Samples Prepared from Dispersions.

| | | Fraction | | Omicure | TackForce- | TackForce- | | |
|---|---|---|---|---|---|---|---|---|
| | | D.E.N. | DICY | U-410M | Average | StdDev | Initial | Cured |
| | SER | 438* | PHR | PHR | (g) | (g) | Tg (° C.) | Tg (° C.) |
| Example 1 | D.E.R. | 0.35 | 6.51 | 7 | 0.5 | 0.1 | 16.4 | 131.6 |
| | 6508 | | | | | | | |
| Example 2 | D.E.R. | 0.65 | 8.20 | 5 | 13.3 | 1.3 | 6.8 | 145.1 |
| | 6508 | | | | | | | |
| Comparative 1 | D.E.R. | 0.35 | 3.20 | 5 | 0.6 | 0.5 | 20.0 | 93.5 |
| | 664 | | | | | | | |
| Comparative 2 | D.E.R. | 0.65 | 4.81 | 7 | 13.1 | 2.6 | 9.5 | 92.9 |
| | 664 | | | | | | | |

*Weight fraction of the 100 parts epoxy resin blend.

### 2. Example 3

Example 3 was a blend of oxazolidone-containing solid epoxy resin (D.E.R. 6508) with latent hardener (DICY, Technicure NanoDicy), and latent catalyst (TBDU, OMICURE U-410M). The blend was prepared by first making a 50 wt % percent solution of D.E.R. 6508 in acetone and 50 wt % slurries of Technicure NanoDicy and Omicure U-410M in acetone and then mixing these in a ratio to achieve a composition by weight of 93.4% D.E.R. 6508, 1.9% Omicure U-410M, and 4.7% Technicure NanoDicy. DSC samples were prepared by adding the solution/slurry blend to a DSC pan and drying at 45° C. under vacuum.

### 3. Examples 4-11 and Comparative 3-13

Samples with the compositions listed in Table 2 (excepting Example 3, see above) were prepared by first making a molten blend of epoxy resins and then dispersing the particulate hardener and catalyst in the molten epoxy blend. A total of 10 grams of epoxy resin(s) was heated in an oven to 120° C. and mixed with a SpeedMixer™ Laboratory Mixer System (FlackTek Inc.) in a 20 Max cup. Resin temperature was allowed to cool below 90° C. before adding the hardener and catalyst. The denoted amounts of catalyst and hardener were added to the top of the cup and immediately placed in a SpeedMixer™ Laboratory Mixer System (FlackTek Inc.) then mixed at 3000 rpm for 1 minute.

Material descriptions for the material codes in Table 2 are as follows:

SER1: Oxazolidone-containing SER, D.E.R. 6508 (available from The Dow Chemical Company) with nominal epoxy equivalent weight (EEW)=400 g/equiv.

SER2: Medium molecular weight solid reaction product of epichlorohydrin and bisphenol A, D.E.R. 664 (available from The Dow Chemical Company) with nominal EEW=915 g/equiv.

SER3: Low molecular weight solid reaction product of epichlorohydrin and bisphenol A, D.E.R. 661 (available from The Dow Chemical Company) with nominal EEW=530 g/equiv.

ER1: Liquid epoxy resin, diglycidyl ether of bisphenol A, D.E.R. 331 (available from The Dow Chemical Company) with nominal EEW=187 g/equiv.

ER2: Epoxy novolac resin, D.E.N. 438 (available from The Dow Chemical Company) with nominal EEW=178 g/equiv and nominal functionality=3.6.

DICY: Dicyandiamide, a latent hardener. Commercial product used was Technicure® NanoDicy (available from AC Catalysts, Inc.), a micronized product with nominal equivalent weight=21 g/equiv and nominal functionality=4.

CAT1: Toluene bis dimethyl urea, a latent catalyst. Commercial product used was mixed isomer TBDU, OMICURE™ U-410M (available from Diamond Performance Materials).

CAT2: 2,4-diamino-6-[2′-methylimidazolyl-(1′)]-ethyl-s-triazine, a latent catalyst. Commercial product used was Curezol 2MZ-A PW (produced by Shikoku Chemical Corporation, distributed by Air Products in the United States). DSC samples were prepared by placing 5 to 15 mg of melt-blended resin formulation in hermetically sealed DSC pans. Uncured and cured T_{g}s as reported in Table 2 were determined by the 5-step protocol described under Testing Methods.

TABLE 2
Compositions and Properties for Melt-Blended* Samples.

| | Composition (PHR) | | | | | | | | Tg (° C.) | |
|---|---|---|---|---|---|---|---|---|---|---|
| | SER1 | SER2 | SER3 | ER1 | ER2 | DICY | CAT1 | CAT2 | Uncured | Cured |
| Example | | | | | | | | | | |
| 3 | 100 | — | — | — | — | 5.02 | 2 | — | 46 | 152 |
| 4 | 75 | — | — | 25 | — | 6.68 | 4 | — | 25 | 149 |
| 5 | 75 | — | — | — | 25 | 6.93 | 4 | — | 26 | 164 |
| 6 | 50 | — | — | — | 50 | 8.51 | 5 | — | 23 | 164 |
| 7 | 50 | — | — | — | 50 | 8.51 | — | 2.5 | 23 | 162 |
| 8 | 40 | — | — | — | 60 | 9.18 | — | 2.5 | 15 | 164 |
| 9 | 30 | — | — | 17.5 | 52.5 | 9.73 | — | 2.5 | 6 | 160 |
| 10 | 40 | — | — | 15 | 45 | 9.09 | — | 2.5 | 11 | 159 |
| 11 | 40 | — | — | 20 | 40 | 9.07 | — | 2.5 | 9 | 157 |
| Comparative | | | | | | | | | | |
| 4 | — | 25 | — | — | 75 | 9.87 | 4 | — | 13 | 163 |
| 5 | — | 75 | — | — | 25 | 5.37 | 4 | — | 41 | 105 |
| 6 | — | 25 | — | 75 | — | 9.11 | 4 | — | −5 | 127 |
| 7 | — | 75 | — | 25 | — | 5.12 | 4 | — | 35 | 112 |
| 8 | — | — | 25 | — | 75 | 10.15 | 4 | — | 12 | 161 |
| 9 | — | — | 75 | — | 25 | 6.21 | 4 | — | 30 | 127 |
| 10 | — | — | 25 | 75 | — | 9.40 | 4 | — | −6 | 125 |
| 11 | — | — | 75 | 25 | — | 5.96 | 4 | — | 21 | 116 |
| 12 | — | — | 40 | 15 | 45 | 8.58 | — | 2.5 | 11 | 134 |
| 13 | — | — | — | — | 100 | 11.8 | 4 | — | 3 | 172 |

*Example 3 was prepared by a non-melt-blending procedure.

Examples 3 through 7 are illustrative of compositions comprising oxazolidone-containing SERs which possess the beneficial combination of properties required for low-cost automated composites manufacturing processes: (a) an uncured T_{g}≧20° C. to provide the low level of tackiness at ambient temperatures that is required for operations such as automated prepreg layup and production, storage, and handling of non-fusing forms of molding compounds such as pellets or sheets; and (b) a cured T_{g}≧150° C. after cure at a temperature of 150° C., which not only enables parts to have sufficient integrity to be demolded without first cooling the mold and part (which in turn enables shorter molding cycle time) but which also provides a composite material with the property of high heat distortion temperature which is needed for demanding applications. None of the Comparative examples, which lack oxazolidone-containing SER, provide the same beneficial combination of properties. Comparative examples 4, 8, and 13 possess a high cured T_{g}but have uncured T_{g}<20° C. and thus would be excessively tacky for automated layup and similar operations. Comparative examples possess uncured T_{g}≧20° C. and thus would be sufficiently non-tacky for automated layup but have cured T_{g}<130° C. and thus would not be readily demoldable without cooling at a molding temperature of 150° C. nor would they possess the heat resistance necessary for demanding applications.

The benefits of compositions comprising oxazolidone-containing SERs extend beyond compositions which provide both the above benefits in combination. In more conventional composites manufacturing processes such as hand layup of prepregs, a controlled tackiness is desirable and typically T_{g}is adjusted to control tack to the desired level. However, even for such more conventional types of composite manufacturing processes, a cured T_{g}≧150° C. is desirable for the above-mentioned reasons. Examples 8 through 11 are illustrative of compositions comprising oxazolidone-containing SERs and further comprising no more than 65 weight % of epoxy novolac resins which provide varying degrees of tackiness at ambient temperatures (i.e., uncured T_{g}s for these Examples range from 6 to 15° C.) and which further provide a cured T_{g}≧150° C. with attendant benefits for demolding and end-use properties as described above. Although Comparative examples 4, 8, and 13 provide similar combination of uncured T_{g}<20° C. and cured T_{g}≧150° C., they suffer from the deficiency of excessively high level of cross-linking with correspondingly lower strength and toughness as compared to Examples 8-11 of this invention. In these Comparative examples, epoxy novolac resin comprises greater than 65 weight % of the epoxy resin composition which although it provides cured T_{g}≧150° C., this is achieved through levels of cross-linking which are too high to provide adequate strength and toughness for many applications and thus are less desirable compositions than the inventive Examples 8-11 in terms of strength and toughness.

### 4. Preparation of Carbon Fiber Composite Samples by an Extrusion Process (Examples 12 and 13)

Examples 12 and 13 were prepared following a one-step extrusion compounding process. A 25 mm twin-screw extruder was used to make a fully formulated epoxy compound with chopped carbon fiber reinforcement. The following components, in order of addition within the process, were blended in the extruder: D.E.R.™ 6508 solid epoxy resin containing oxazolidone (available from The Dow Chemical Company), D.E.R.™ 331 liquid epoxy resin (available from The Dow Chemical Company), a powder blend of Technicure® NanoDicy (available from AC Catalysts Inc.) and Omicure™ U-410M (available from Diamond Performance Materials), and 6 mm length AC 3101 pre-chopped carbon fiber (available from DowAksa).

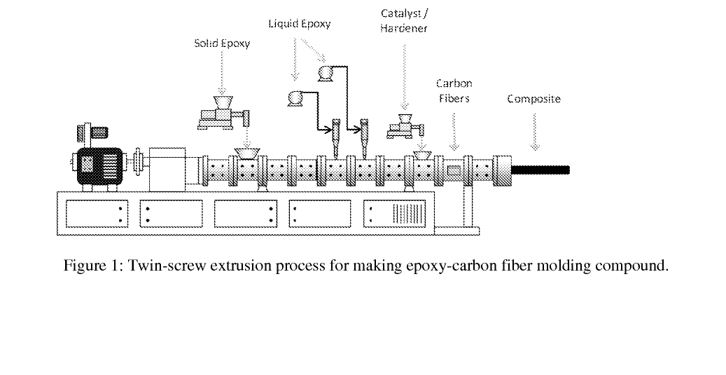

FIG. 1 shows the layout of the process described. The extruder was operated using a screw design and processing conditions optimized to prevent any curing of the epoxy within the extruder and to minimize fiber attrition. The processing conditions for these examples are presented in Table 3. The epoxy-carbon fiber composites thus prepared were collected in the shape of cylindrical logs.

TABLE 3
Processing conditions in a 25 mm Twin Screw Extruder.

| | | | Extrudate |
|---|---|---|---|
| Formulation ID | Screw RPM | Torque (%) | Temperature (° C.) |
| Example 12 | 130 | 46 | 90 |
| Example 13 | 250 | 34 | 88 |

The uncured and cured T_{g}s of these epoxy-carbon fiber molding compounds were measured by the 5-step DSC protocol described under Testing methods on 5 to 12 mg specimens in hermetically-sealed aluminum DSC pans. Compositions and T_{g}s of Examples 12 and 13 are given in Table 4.

TABLE 4
Composition and Properties of Epoxy-Carbon Fiber Molding
Compounds.

| | | | Fraction of | | Omicure | | |
|---|---|---|---|---|---|---|---|
| | | Additional | Additional | DICY | u-410M | Initial Tg | Cured |
| | SER | Resin | Resin | PHR | PHR | (° C.) | Tg (° C.) |
| Example 12 | D.E.R. 6508 | D.E.R. 331 | 0.3 | 7.00 | 3.7 | 20.7 | 141.3 |
| Example 13 | D.E.R. 6508 | D.E.R. 331 | 0.4 | 7.60 | 4 | 16.6 | 138.8 |

### 5. Compression Molding of Epoxy-Carbon Fiber Molding Compounds

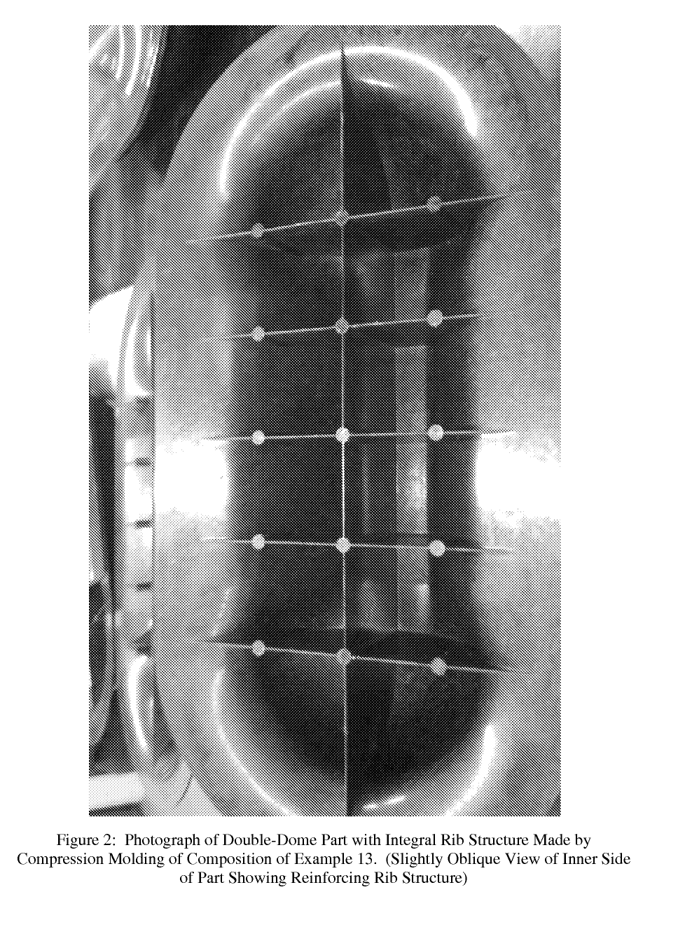

The epoxy-carbon fiber compositions of Examples 12 and 13 were compression molded into a double-dome shape with incorporated ribbing using a compression molding press with a matched metal mold. A photograph of the final molded double-dome part with integral ribs which was made from the molding compound of Example 13 is shown in FIG. 2. The molding process was accomplished by first preheating to 75+/−5° C. three 300 to 500 g cylindrical logs that had been collected from the extruder. The three preheated logs totaling 1.3 to 1.5 kg of material were then placed into a mold situated within a compression molding press, where the mold was preheated to 150° C. Material was held in the 150° C. mold for 1 min before closing the press. Material was then cured in the closed mold at 150° C. for 14 minutes at an applied force of 2250 kN. The composite was immediately demolded at 150° C., showing the benefit of the high cured T_{g} of these compositions for demolding from a hot mold. As can be seen from FIG. 2, the flow of the epoxy-carbon fiber molding compound in the mold to form this complex part was excellent, even into the tips of the integral rib structure. Little to no separation of carbon fiber from the resin during flow into the complex structure was observed.

### 6. Preparation of Epoxy-Carbon Fiber Prepregs (Examples 14 and 15)

A unidirectional epoxy-carbon fiber prepreg (Example 14) was prepared as follows. An epoxy resin blend consisting of 50 weight % of an oxazolidone-containing SER (D.E.R. 6508, available from The Dow Chemical Company) plus 50 weight % of an epoxy novolac resin (D.E.N. 438, available from The Dow Chemical Company) was prepared by melt compounding with a 25 mm twin-screw extruder, with the extrudate collected in metal pails which were then allowed to cool to room temperature. This epoxy blend was subsequently combined with hardener and catalyst, with the resulting fully formulated epoxy resin system used to prepare an epoxy resin coating on silicone-treated release paper. The fully formulated resin system was prepared by reheating 11.4 kg of the epoxy blend in a 5 gallon metal pail to a temperature of 82° C. A latent hardener (Technicure NanoDicy, available from AC Catalysts Inc.) and latent catalyst (Omicure U-410M, available from Diamond Performance Materials) were then added under agitation to the heated epoxy blend in the amounts of 971 g and 456 g, respectively. Agitation was performed via an overhead mixing impeller equipped with a 13.4 cm diameter Cowles blade operated at about 1300 rpm. Total mixing time was about 3 minutes, resulting in a homogeneous clump-free dispersion of the hardener and catalyst in the epoxy resin blend, at a final temperature of about 85° C. due to a minor degree of shear heating during the mixing process. The fully formulated resin system was immediately poured into the gap between two oil-heated nip rollers (oil temperature 83° C.). To prepare the coating, the release paper was fed into the nip over a rotating roller through the resin with the other roller stationary. Dams were set 94 cm apart in the nip to control the width of the coating. The gap and parallelism between the nip rollers were adjusted until the desired coating weight of 55 grams per square meter (gsm) was obtained uniformly within 2 gsm across the coating width, as verified by weighing 10×10 cm squares of coated versus uncoated release paper. A gamma gauge was then used to monitor coating thickness during the remainder of the coating process, with random process variability of about ±3 gsm. Line speed during the coating process was 5.2 meters per minute (mpm). The epoxy resin coated release paper was collected on a takeup roller at a distance down the line where the coating had cooled to a slightly tacky state.

Unidirectional epoxy-carbon fiber prepreg was then prepared by merging two layers of coating with multiple tows of carbon fiber by passing coatings and fiber simultaneously between two heated nip rollers in a continuous process. A creel with 110 spools of AKSA 24K A-42 carbon fiber was used to supply continuous tows of carbon fiber to the process. The carbon fiber tows were passed through combs to set uniform spacing between tow centers across the width of the prepreg. Prior to entering the nip rollers, the tows were then passed through a device to spread the tows into a gap-free array of carbon fibers across the width of the prepreg. Epoxy resin coated release paper was introduced onto each of the counter-rotating oil-heated nip rollers (oil temperature of 86° C.), one at a location equal to half the circumference away from the nip, the other about three-eighths of the circumference away from the nip. With this arrangement, the resin coating was fully heated to the surface temperature of the nip rollers by the time it reached the nip where it was merged with the carbon fibers. The gap between the nip rollers was set to provide a several millimeter wide bead of fluxed resin in the gap of the nip rollers where it contacted the carbon fibers, with the setting further to provide the desired resin content of the prepreg. This prepregging process was operated at a line speed of 1.7 mpm. The symmetric sandwich of carbon fiber between two epoxy-coated release papers emerging from the nip rollers was further passed through a second set of oil-heated compaction rollers (oil temperature of 86° C.) to further promote impregnation of the formulated epoxy resin system into the fibers. The edges of the resultant prepreg were slit to yield a final width of 91.4 cm and the prepreg was collected on a takeup roller. The overall prepreg areal weight (in units of gsm) was determined gravimetrically as the difference in weights between 10×10 cm squares of release paper plus prepreg versus release paper alone. The fiber areal weight (in units of gsm) was determined on a 10×10 cm square of prepreg by dissolving the resin system off the fibers and further washing then drying and weighing the fibers. The resin areal weight was determined as the difference between the prepreg and fiber areal weights. Resin content (in units of weight %) was calculated as 100 times the ratio of resin areal weight to prepreg areal weight. These measurements were done in the center of the prepreg and at the operator and machine side of the web to assess side-to-side uniformity. The final unidirectional epoxy-carbon fiber prepreg was gap-free and had good uniformity across the width, with average resin content of 37.0 weight % (36.7, 36.9, 37.2), average prepreg areal weight of 297.7 gsm (297, 298, 298), average fiber areal weight of 187.7 gsm (188, 188, 187), and average resin areal weight of 110.0 gsm (109, 110, 111).

An epoxy-carbon fiber fabric prepreg (Example 15) was prepared by a similar process as described above for Example 14, but substituting a woven carbon fiber fabric for the continuous fiber reinforcement. Procedures for making the epoxy blend and adding the latent hardener and catalyst were the same as described for Example 14. Epoxy-coated release paper was made at two different coating areal weights, 240 gsm and 168 gsm, using the basic procedure described above for Example 14. Coating areal weights were determined by the gravimetric procedure above. Conditions for preparing coatings for Example 15 were slightly different than those of Example 14: nip rolls were heated with oil temperature of 87° C., line speed was 5.2 mpm, and coating width was about 106 cm. Prepreg was prepared by the basic procedure described above, but using a 102 cm wide 670 gsm fiber areal weight 2×2 twill-weave carbon fiber fabric (product code CW670A, available from Metyx) woven from AKSA 12K A-42 carbon fiber. This fabric was fed together with the 168 and 240 gsm epoxy coatings through the heated nip rollers and second compaction roller set, with the oil temperature at 95.5° C. for both the nip and compaction roller sets and line speed of 1.2 mpm. The epoxy-woven carbon fiber prepreg which was produced had a resin content of 38 weight %, prepreg areal weight of 1080 gsm, fiber areal weight of 670 gsm, and resin areal weight of 410 gsm. The resultant prepreg was what is commonly called a semi-preg, a designation referring to partial impregnation of the resin into the carbon fiber fabric with resin-rich layers on the outer surfaces of the prepreg.

### 7. Molding and Properties of Epoxy-Carbon Fiber Prepreg of Examples 14 and 15.

Cured composite laminates were prepared from the prepregs of Examples 14 and 15 by compression molding. Prepregs were cut into squares and stacked to make the following laminate layups:

Unidirectional prepreg (Example 14): [0°]₆, [0°]₁₀, dimensions 30.5×30.5 cm

Woven fabric prepreg (Example 15): [0°]₄, dimensions 61×61 cm

where the angle in the brackets denotes the subtended angle between the edge of the ply and either the unidirectional fiber tow direction (Ex. 14) or the warp fiber tow direction (Ex. 15), and the subscript denotes the number of plies in the stacked laminate layup.

These laminates were molded and cured using a compression molding press with the two matched mold halves affixed to the opposite heated platens of the press using the following general procedure: (1) Place the stacked layup into a mold preheated to 150° C.; (2) Hold the mold open for a specified time at zero applied force, during which time the laminate is heated towards the mold temperature; (3) Close the press and mold to consolidate and cure the laminate panel, at a mold temperature of 150° C. at specified force for a specified time; and (4) Open the press and mold then remove the cured epoxy-carbon fiber composite panel. Specific conditions for molding were as follows:

Example 14: hold time 15 s, applied force 1000 kN, cure time 3 min

Example 15: hold time 30 s, applied force 5350 kN, cure time 3 min

The composite panels were cut into specimens for tensile and compression testing (longitudinal and transverse for Example 14, longitudinal only for Example 15) using a diamond saw. The measured mechanical properties are summarized in Table 5 as the mean and standard deviation for five specimens.

TABLE 5
Mechanical Properties of Composite Laminates Prepared from Epoxy-
Carbon Fiber Prepregs of Examples 14 and 15.

| | Example 14 | | Example 15 | |
|---|---|---|---|---|
| Property | Mean | Std. dev. | Mean | Std. dev. |
| Tensile modulus (GPa) | | | | |
| longitudinal | 147 | 10 | 62.4 | 5.1 |
| transverse | 9 | 0.3 | — | — |
| Tensile strength (MPa) | | | | |
| longitudinal | 1600 | 200 | 624 | 34 |
| transverse | 23 | 0.6 | — | — |
| Compressive strength (MPa) | | | | |
| longitudinal | 807 | 71 | 273 | 79 |
| transverse | 113 | 8 | — | — |

The measured composite mechanical properties are consistent with those expected based on the properties of the constituents of the cured composite (i.e., carbon fiber and cured epoxy system) and the fiber orientation and fiber volume fraction.

1. A resin composition comprising
a. a first epoxy resin component;
b. a second epoxy resin component;
c. a latent hardener; and
d. a latent catalyst;
wherein the first epoxy resin component contains an oxazolidone.

2. The resin composition according to claim 1 wherein the oxazolidone is a compound having the Formula (I):

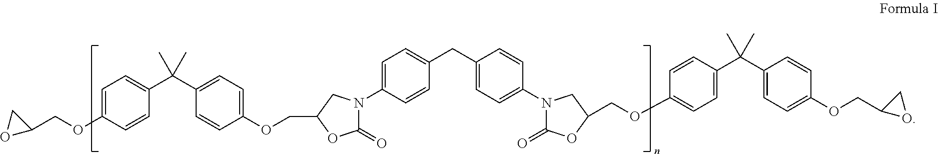

3. The resin composition according to claim 2 comprising about 30 to 100 wt % of the first epoxy resin component containing a solid epoxy-terminated polyoxazolidone resin; and the second epoxy resin component being a liquid bis-A based epoxy resin.

4. The resin composition according to claim 2 comprising about 30 to 100 wt % of the first epoxy resin component containing a solid epoxy-terminated polyoxazolidone resin; and the second epoxy resin component being an epoxy novolac resin.

5. The resin composition according to claim 2, wherein the second epoxy resin component comprises 10 to 20 wt % of liquid bis-A based epoxy resin and 40 to 60 wt % epoxy novolac resin, all based on total weight of the resin composition.

6. The resin composition according to claim 2 wherein the equivalent ratio between the epoxy components/hardner is 0.75 to 2.

7. The resin composition according to claim 2, wherein the latent catalyst comprises a substituted urea catalyst at a level of 2 to 5 PHR.

8. The resin composition according to claim 7 wherein the latent catalyst comprises a latent imidazole catalyst at a level of 1 to 3 PHR.

9. The resin composition according to claim 2, wherein the oxazolidone is a reaction product formed by reacting a polyepoxide compound with a polyisocyanate compound.

10. The resin composition according to claim 9, wherein the polyepoxide compound comprises more than one 1,2-epoxy group.

11. A resin composition comprising, with all weight percentage based on total weight of the resin composition.
a. 30 to 100 wt % of a first epoxy resin component containing a solid epoxy-terminated polyoxazolidone resin;
b. a second epoxy resin component comprising 10 to 20 wt % liquid epoxy resin and 40 to 60 wt % epoxy novolac resin;
c. a latent hardener; and
d. a latent catalyst comprising a latent imidazole catalyst at a level of 1 to 3 PHR;
wherein equivalent ration between the epoxy components of a and b/the latent hardner is 0.75 to 2;
wherein the first epoxy resin component contains an oxazolidone being a reaction product formed by reacting a polyepoxide compound with a polyisocyanate compound; and having a chemical structure containing [chemical structure]
